(19) United States
(12) Patent Application Publication
(10) Pub. No.: US 2007/0212294 A1
(43) Pub. Date: Sep. 13, 2007

(54) Fuel reformer comprising spraying device, sprayer used in the fuel reformer and fuel reforming method

(75) Inventors: Inyong Kang, Daejeon (KR); Joongmyeon Bae, Daejeon (KR); Hyunjin Ji, Daejeon (KR)

Correspondence Address: CANTOR COLBURN, LLP, 55 GRIFFIN ROAD SOUTH, BLOOMFIELD, CT, 06002, US

(73) Assignee: KOREA ADVANCED INSTITUTE OF SCIENCE AND TECHNOLOGY, Daejeon (KR)

(21) Appl. No.: 11/549,359

(22) Filed: Oct. 13, 2006

(30) Foreign Application Priority Data
Mar. 10, 2006 (KR) 10-2006-0022717

(51) Int. Cl. C01B 3/26; B01J 8/00; B01J 19/00

(52) U.S. Cl. 423/652; 422/187; 422/198; 422/211

(57) ABSTRACT

The present invention relates to a fuel reformer, a sprayer for the fuel reformer and a fuel reforming method, wherein the fuel reformer is characterized by comprising a spraying device for atomizing liquid fuel; and a reactor which reforms the fuel via a catalytic reaction of the fuel atomized by the spraying device.

According to the invention, the reforming performance of a fuel reformer can be enhanced, and the reforming can be easily carried out when it is applied to the fuel comprising improper features for fuel reforming.

### FIELD OF THE INVENTION

The present invention relates to a fuel reformer, a sprayer for the fuel reformer and a fuel reforming method, more specifically, it relates to a fuel reformer comprising a spraying device to atomize liquid fuel, a sprayer for the fuel reformer and a fuel reforming method.

### BACKGROUND OF THE RELATED ART

Recently, developments of fuel cells to be used in automobiles or the like have been actively performed owing to current legislations in various countries to prevent environmental pollution. Fuel cells store gases such as hydrogen as the energy source, which have excellent electrochemical reaction properties and minimize the problem of exhaust gas, and include solid oxide fuel cells (SOFC), molten carbonate fuel cells (MCFC), phosphoric acid fuel cells (PAFC), polymer electrolyte fuel cells, or the like, depending on the electrolytic components. The vehicles to which such fuel cells are applied are disclosed in Korean Patent Registration No. 456300 entitled “Fuel cell vehicles” (Registration date: Oct. 29, 2004).

As described in said registered patent, a vehicle to which a fuel cell technique has been applied is generally provided with a fuel reformer in order to separate gases for burning such as hydrogen from the fossil fuel and to supply it to said fuel cell. Thus it is found that the reforming performance of said fuel reformer largely affects on the utility factor of fuel. The present invention is proposed to enhance the performance of such fuel reformers.

In the meanwhile, diesel oil attracts attention as a fuel to be reformed, showing higher hydrogen content as compared to gasoline, natural gas, or the like. However, since diesel oil is difficult to be vaporized because of its high boiling point, and pulsation occurs because of its high viscosity at the time of supplying, so that it is hard to supply diesel in a state appropriate for fuel reforming.

### SUMMARY OF THE INVENTION

The object of the present invention is to provide a fuel reformer having enhanced reforming performance, a sprayer for the fuel reformer and a fuel reforming method.

In addition, the object of the present invention is to provide a fuel reformer which can easily reform the fuel which comprises improper features for fuel reforming, a sprayer for the fuel reformer and a fuel reforming method.

Another object of the invention is to provide a fuel reformer which can easily reform liquid fuel comprising any one of gasoline, kerosene, methanol, ethanol, GTL fuel, or a combination thereof, a sprayer for the fuel reformer and a fuel reforming method.

In order to achieve the objects described above, the present invention provides a fuel reformer which comprises a spraying device to atomize liquid fuel; and a reactor which reforms the fuel via a catalytic reaction of the fuel atomized by the spraying device.

### BRIEF DESCRIPTION OF DRAWINGS

FIG. 1 is a schematic diagram to represent the structure of a fuel reformer according to an embodiment of the present invention;

FIGS. 2a and 2b are perspective view and cross-sectional view, respectively, showing the structure of the spraying device of FIG. 1;

FIGS. 3 and 4 are graphs comparatively showing the performance between the fuel reformer according to an embodiment of the present invention and a conventional fuel reformer;

FIG. 5 is a flow chart to explain the fuel reforming method according to an embodiment of the present invention; and

FIG. 6 is a flow chart to explain the fuel reforming method according to another embodiment of the present invention.

### DESCRIPTION OF SYMBOLS FOR IMPORTANT PARTS OF THE DRAWINGS

10: a fuel reformer

100: a spraying device

110: an ultrasonic sprayer

111: a fuel inlet

112: a nozzle head

113: a nozzle end

120: a housing for cooling

121: a inlet for refrigerant

122: an outlet for refrigerant

200: a reactor

201: a catalyst layer

202: a heater/insulator

300: a union pipe

Other and further objects, features and advantages of the invention will appear more fully from the following description.

### DETAILED DESCRIPTION OF THE PREFERRED EMBODIMENT

The spraying device herein generally refers to a device which applies mechanical energy to liquid to create minute liquid drops. Widely used spraying devices include a pressure-type sprayer wherein a liquid of high pressure is jetted via a nozzle so that the liquid drops are finely divided owing to instability of liquid jet surface by friction with the stationary open air (for example, an orchard insecticidal sprayer, a fuel jet for a diesel engine, liquid sprayer for window cleaner, etc.), a 2-fluid sprayer taking advantage of relative speed difference of pressurized gas (air) from the liquid (a piston-sprayer using Bernoulli's principle, an industrial coater, etc.), a rotary sprayer which atomizes liquid film on a rotary disc at high speed (widely used in mushroom growing industry). Besides, a vapor sprayer using thermal energy (widely used in semiconductor industry for controlling temperature and humidity, in a laundry, etc.), a spraying metal coating, and the like have been known. As the spraying device used in the present invention, said pressure-type sprayers, 2-fluid sprayers, rotary sprayers or the vapor generating sprayers using thermal energy may be applied. In particular, an ultrasonic sprayer which atomizes liquid fuel by generating ultrasonic vibrations may be included.

In this case, a cooler for cooling the ultrasonic sprayer may be further included.

Said cooler may comprise a housing for cooling which accommodates at least a part of said ultrasonic sprayer, and a means for supplying a refrigerant to said ultrasonic sprayer through said housing for cooling.

Further, said ultrasonic sprayer comprises a nozzle end which discharges sprayed fuel, and said housing for cooling has an outlet for refrigerant which conforms to said nozzle end.

Said refrigerant comprises at least one selected from air and nitrogen.

In addition, said fuel reformer may further comprise a mixing means for mixing the fuel atomized by said spraying device with open air and supplying the mixture to said reactor, which is interposed between said spraying device and said reactor.

In this case, said mixing means may comprise a union pipe.

Said open air comprises steam or a mixed gas containing steam and oxygen.

Said liquid fuel comprises diesel oil, which may be used in a combination with a fuel selected from gasoline, kerosene, methanol, ethanol and GTL fuel or a combination thereof.

Said liquid fuel comprises water, and said spraying device may atomize said water together with said liquid fuel.

In the meanwhile, the present invention provides an ultrasonic sprayer for a fuel reformer, which atomizes liquid fuel by generating ultrasonic vibrations, in order to achieve said objects of the invention.

In addition, the present invention provides a fuel reforming method which comprises steps of atomizing liquid fuel; and reforming said atomized fuel via catalytic reaction, in order to achieve said objects of the invention.

Said atomizing step herein comprises a step of atomizing said liquid fuel via ultrasonic vibrations.

The fuel reforming method further comprises a step of mixing said atomized fuel and steam with oxygen or air, and the reforming step comprises a step of performing a catalytic reaction of said steam, oxygen or air with the atomized fuel to reform the fuel.

Moreover, the present invention provides, in order to achieve said objects of the invention, a fuel reforming method which comprises a step of atomizing a mixture of liquid fuel and water; and a step of performing a catalytic reaction of said atomized fuel and water with oxygen or air to reform the fuel.

Now the present invention will be described in detail by referring to the drawings attached.

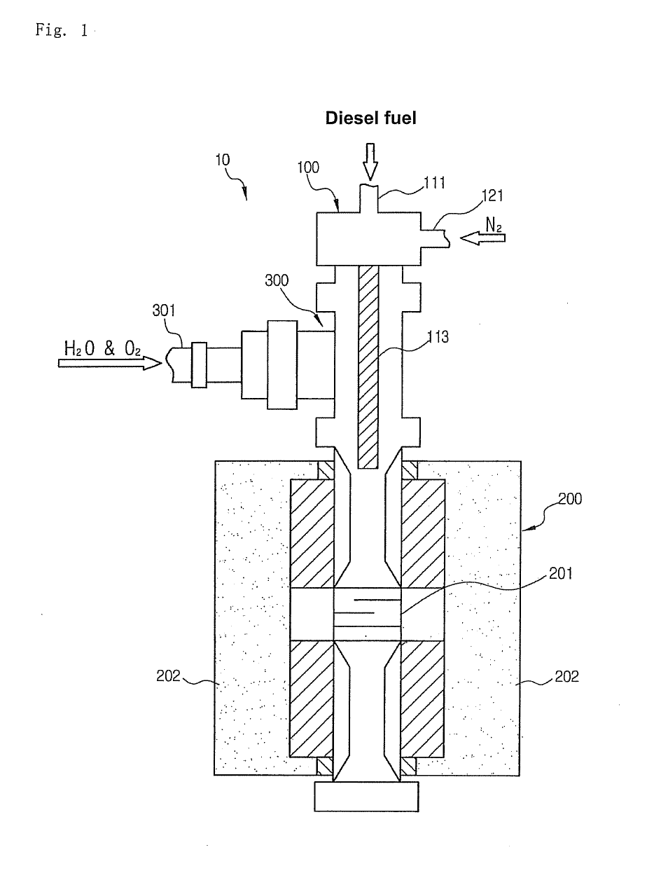

A fuel reformer (10) according to an embodiment of the present invention comprises a spraying device (100) which atomizes liquid fuel, a reactor (200) which reforms the fuel atomized by the spraying device (100) via a catalytic reaction, and a union pipe (300) interposed between the spraying device (100) and the reactor (200) in order to add open air to said atomized fuel, as illustrated in FIG. 1.

The spraying device (100) is provided with a fuel inlet (111) through which liquid diesel oil enters, and an inlet for refrigerant which cools the spraying device (100) itself. The diesel oil which entered via the fuel inlet (111) is atomized by ultrasonic vibrations, and discharged through a nozzle end (113). Nitrogen as a refrigerant enters through a refrigerant inlet (121). Refrigerant may be air or other kind of gas or a mixed gas, as well as nitrogen.

The union pipe (300) is connected to the spraying device (100) and the reactor (200), respectively, via openings of both ends, and steam and oxygen (which corresponds to the open air) enters through the third inlet (301). Thus, the union pipe (300) serves as a means for mixing gases by supplying the atomized diesel oil discharged through the nozzle end (113) of the spraying device (100) being mixed with said steam, and air or oxygen.

The reactor (200) comprises a catalytic layer (201) which performs catalytic reaction of the entered diesel oil, steam and oxygen or air or the like and separates hydrogen, carbonic acid gas (including carbon dioxide and carbon monoxide), methane or the like therefrom; and a heater/insulator (202) so that the catalyst layer (201) is heated or insulated to facilitate the catalytic reaction at a desired temperature. The exhaust gas (such as hydrogen) that is discharged after reforming in the reactor (200) may also be supplied to a fuel cell (not shown) or the like.

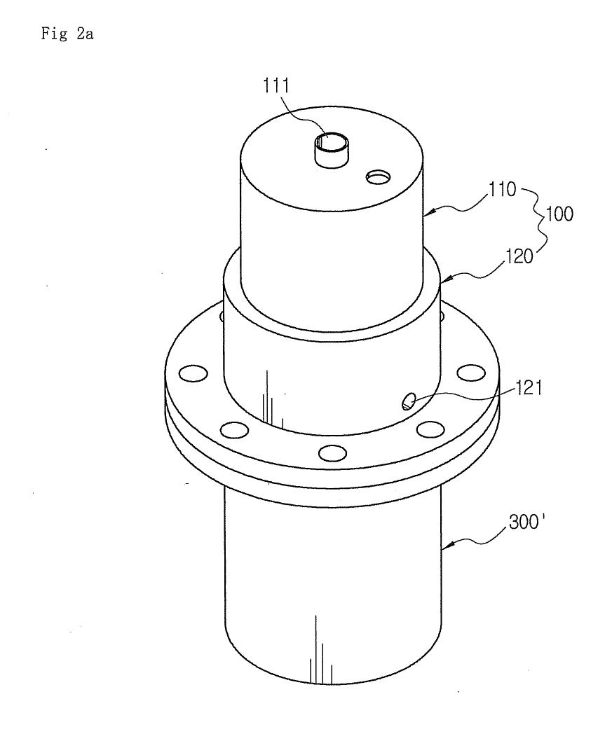

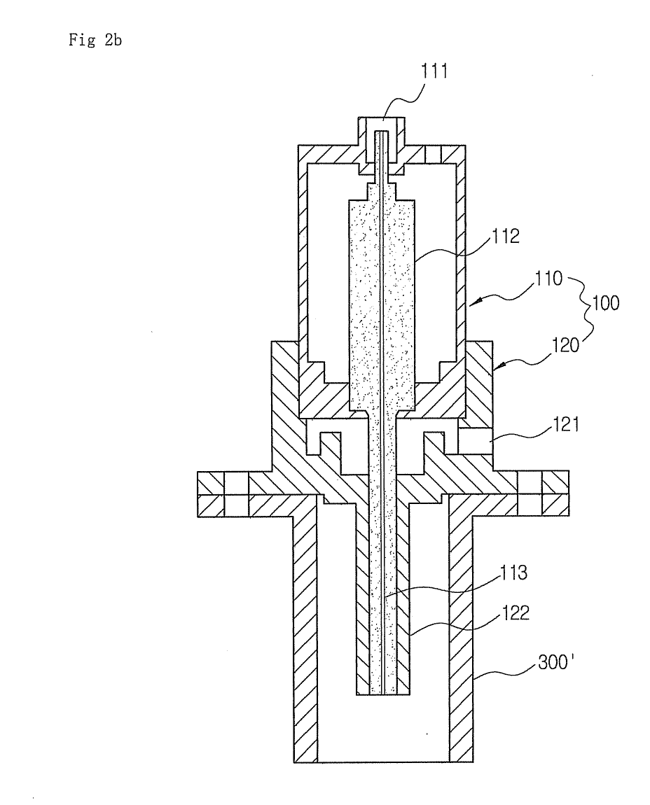

FIG. 2a and FIG. 2b are detailed perspective view and cross-sectional view of the spraying device (100), respectively. The spraying device (100) comprises an ultrasonic sprayer (110) which atomizes said liquid diesel oil entered, by generating ultrasonic vibration, and a housing for cooling (120) to cool said ultrasonic sprayer (110).

The ultrasonic sprayer (110) is provided with a piezoelectric transducer (not shown) by which electric energy is transformed into mechanical vibratory energy to atomize diesel oil. Thus, diesel oil enters through a fuel inlet (111), passes through a nozzle head (112) that is in gear with said piezoelectric transducer and atomizes at the nozzle end (113) to be expelled. The size of drops of diesel atomized depends on the vibratory frequency of the nozzle head (112), and surface tension and density of diesel oil. In particular, it is supremely affected by vibratory frequency of the nozzle head (112), and it is generally known that the mean diameter of liquid drops is in inverse proportion to ⅔ square of the frequency. Thus, the higher the frequency is, the smaller the size of liquid drops is. In the experiment of the fuel reformer (10) according to the present invention described below, the mean diameter of liquid drops of atomized diesel oil was adjusted to be 35 μm.

General technology of an ultrasonic sprayer (110) is disclosed in Korean Patent Laid-Open No. 2001-70880 (Laid-Open date: Jul. 27, 2001), so the detailed description about it is omitted in this specification. The ultrasonic sprayer (110) applied to an embodiment of the invention is a wide range ultrasonic generator (model name: SM103) from Sysonic Corp. An ultrasonic sprayer, being different from other type of nozzles, generally can spray liquid at a low rate. The spraying rate of said ultrasonic sprayer (110) is usually from 0.25 to 0.5 m/s, and can be as low as from 0.0043 to 0.0087 m/s.

The housing for cooling (120) is a constituent of a cooler (not shown) to cool the ultrasonic sprayer (110), and accommodate the lower part of the ultrasonic sprayer (110) as shown in FIGS. 2a and 2b. Refrigerant enters through a refrigerant inlet (121) provided at one side of the housing for cooling (120), and cools the lower part of the ultrasonic sprayer (110), particularly the nozzle end (113) to a predetermined temperature. As the refrigerant, nitrogen gas, air or a mixed gas may be employed.

The cooler including such a housing for cooling (120) is provided for normal operation of the ultrasonic sprayer (110) within the range of operation temperature (in the present embodiment, it is restricted to a range from about 0 to 40° C.). If there is no restriction in the operation temperature of the ultrasonic sprayer, a housing for cooling (120) may not be provided.

Meanwhile, in the housing for cooling (120), a refrigerant outlet (122) is formed to correspond to the nozzle end (113) of the ultrasonic sprayer. Thus, the refrigerant entered through the refrigerant inlet (121) is discharged through the refrigerant outlet (122), and the discharged refrigerant flows with the atomized diesel discharged through the nozzle end (113) into the reactor (200 of FIG. 1) that is prepared at the lower part. A connecting pipe (300′) is connected at the lower part of the housing for cooling (120). The connecting pipe (300′) may be replaced by other type of pipe such as the union pipe (300) as illustrated in FIG. 1, if necessary.

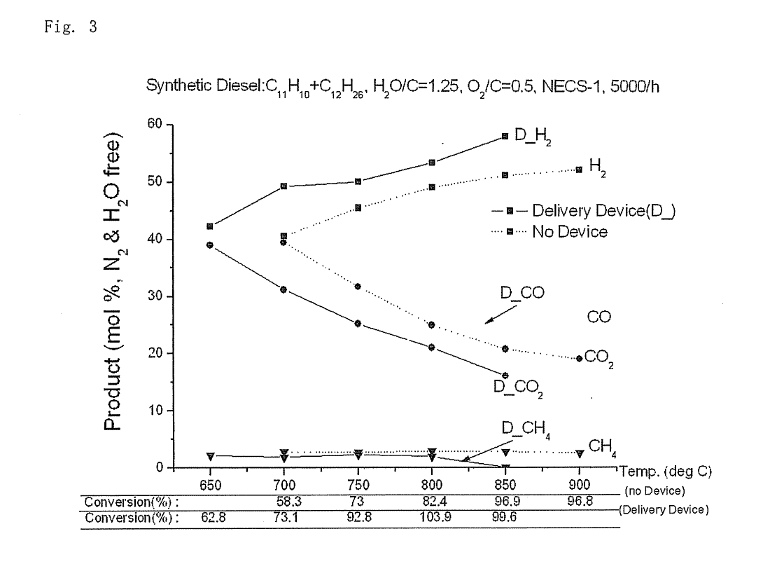

As can be seen from FIG. 3, it is found that mean content of hydrogen at an operation temperature of 850° C. was about 58.1% when the fuel reformer (10) according to the embodiment of the invention was used, while the mean content of hydrogen was about 51.3% when a conventional fuel reformer was used. Thus, it is found that using an ultrasonic sprayer (110) noticeably enhances mean content of hydrogen generated.

FIG. 3 is a graph comparatively showing the composition of gases generated depending on the determined temperature of the reactor (200), by the fuel reformer (10) according to the embodiment of the invention and a conventional fuel reformer, respectively. As can be seen from the graph, the fuel reformer (10) according to an embodiment of the invention provided higher content of hydrogen (H₂) generated on the whole, as compared to that of conventional technique. Moreover, the content of carbon monoxide (CO), which is usable as fuel, was increased, while that of carbon dioxide (CO2), which is unusable as fuel, was reduced, thereby largely enhancing fuel conversion of diesel oil on the whole. Particularly, in the temperature range from 750 to 800° C., the fuel reformer (10) according to an embodiment of the present invention showed increase by about 20% of fuel conversion as compared to conventional fuel reformers.

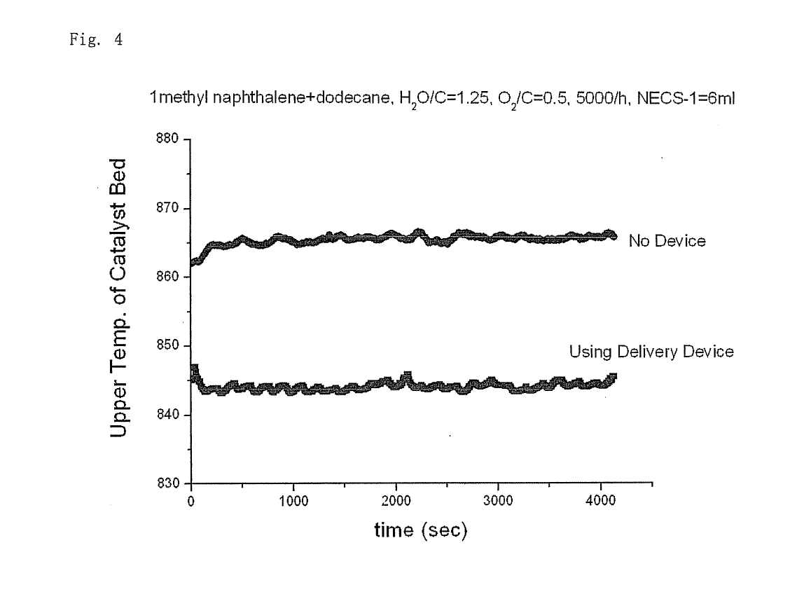

FIG. 4 is a graph showing the temperature measured at the inlet of the catalyst layer (201 of FIG. 1) of the reactors (200) at the time of operation of the fuel reformer (10) according to an embodiment of the invention and a fuel reformer according to a conventional technique, respectively. As can be seen from the drawing, the graph (A) of the embodiment of the present invention shows lower temperature by about 20° C. as compared to that (B) of the conventional technique. Higher temperature at the inlet of the catalysis layer implies higher probability for the entering diesel oil to be converted, even before entering the catalyst layer, to low-molecular hydrocarbon compounds, hydrogen, carbon monoxide or carbon dioxide, that is the probability of premature oxidation of the reactant before contacting with the catalyst layer. Thus, it is considered that the performance of a reformer is enhanced according to the embodiment of the invention, by preventing premature reaction of diesel oil before entering the catalyst layer and inducing effective reforming reaction on the catalyst layer.

In the meanwhile, the fuel reformer (10) shown in FIG. 1 take the mode that diesel oil is atomized via the spraying device (100) and supplied to the reactor (200), while steam by evaporation of water is separately mixed with said atomized diesel oil via the union pipe (300) and supplied to the reactor (200). However, the mode of supplying steam by atomizing it with diesel oil via the spraying device (100) and supplying the mixture to the reactor (200) may be assumed. Though the embodiment described above proposes an ultrasonic sprayer (110) equipped in the spraying device as the spraying means, the fuel reformer according to the present invention is not restricted to the use of an ultrasonic sprayer, but any other spraying means may be provided within the scope of the present invention specified by the claims attached.

Further, though the embodiment described above illustrates only diesel oil as the liquid fuel, the present invention is not restricted to diesel oil, but any liquid fuel selected from gasoline, kerosene, methanol, ethanol, GTL fuel, or a combination thereof may be applied, if necessary.

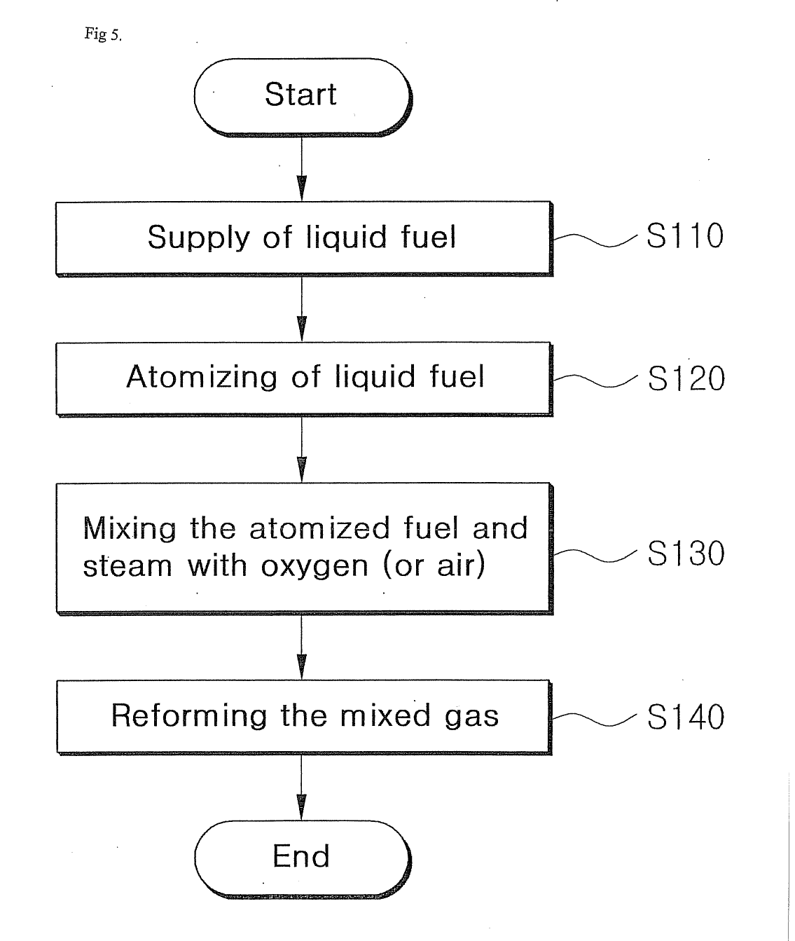

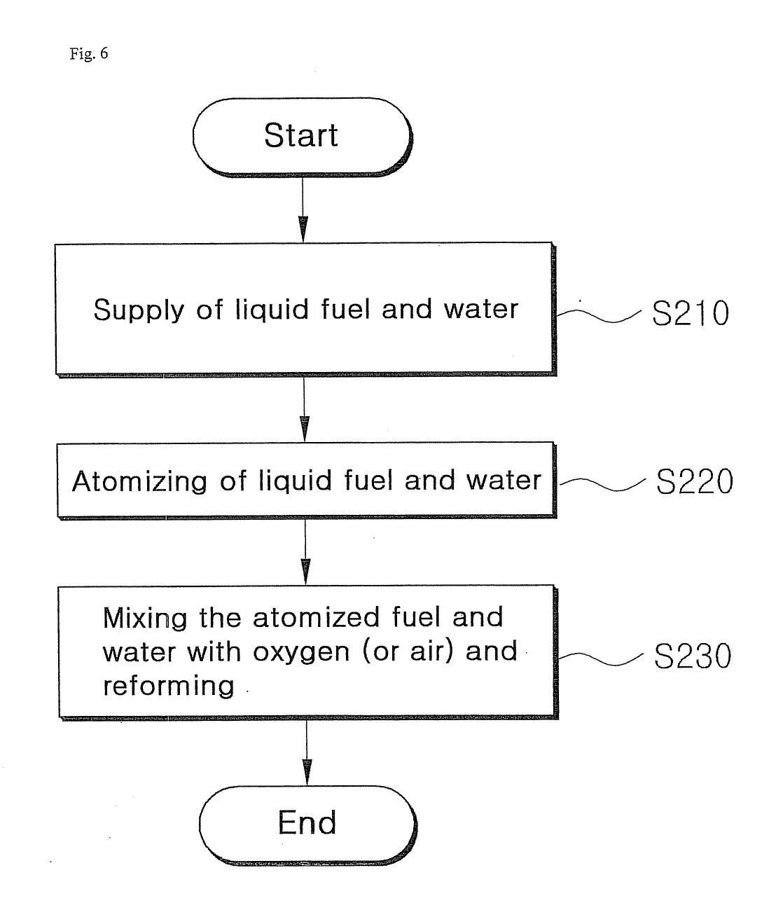

FIG. 5 is a flow chart which explains the fuel reforming method according to an embodiment of the present invention. First, liquid fuel such as diesel is provided (S110), and atomized by a spraying device or the like (S120). Atomization of said liquid fuel herein may be also achieved by ultrasonic vibrations. Then, steam, and oxygen or air are mixed with the atomized fuel (S130), and the mixed gas is reformed by using a catalytic reaction (S140). Such a fuel reforming method can be carried out through the fuel reformer (10 of FIG. 1) as described above.

FIG. 7 is a flow chart which explains the fuel reforming method according to another embodiment of the present invention. According to this embodiment, being different from the embodiment described above, a mixture of liquid fuel and water is provided (S210), and atomized by a spraying device or the like (S220). Then, the atomized fuel and water are reformed with oxygen or air by catalytic reaction (S230). Such a fuel reforming method can be carried out through the fuel reformer as described above.

The present invention illustratively described in each embodiment described above may be provided in a vehicle to which fuel cells has been applied, but the use of the invention is not restricted thereto, but the invention can be widely applied regardless of the use as long as it is a device using hydrogen or any other gas generated via reforming of fuel.

As described above, according to the fuel reformer according to the present invention, the overall reforming performance can be enhanced by atomizing liquid fuel by a spraying device and then supplying it to a reactor for reforming. In particular, the fuel reformer according to the present invention, by virtue of employing said spraying device, can easily carry out reforming with enhanced performance, even it is subjected to a fuel comprising improper features for reforming, such as diesel oil.

1. A fuel reformer characterized by comprising a spraying device to atomize liquid fuel; and
a reactor which reforms the fuel via a catalytic reaction of the fuel atomized by the spraying device.

2. A fuel reformer according to claim 1, which is characterized in that said spraying device comprises an ultrasonic sprayer which atomizes said liquid fuel by generating ultrasonic vibrations.

3. A fuel reformer according to claim 2, which is characterized by further comprising a cooler for cooling said ultrasonic sprayer.

4. A fuel reformer according to claim 3, which is characterized in that said cooler comprises a housing for cooling which accommodates at least a part of said ultrasonic sprayer, and a means for supplying a cooling agent to said ultrasonic sprayer through said housing for cooling.

5. A fuel reformer according to claim 4, wherein said ultrasonic sprayer comprises a nozzle end which discharges sprayed fuel, and said housing for cooling has an outlet for cooling agent which conforms to said nozzle end.

6. A fuel reformer according to claim 4, wherein said cooling agent comprises at least one selected from air and nitrogen.

7. A fuel reformer according to claim 1, wherein a mixing means for mixing the fuel atomized by said spraying device with open air to supply to said reactor is interposed between said spraying device and said reactor.

8. A fuel reformer according to claim 7, wherein said mixing means comprises a union pipe.

9. A fuel reformer according to claim 7, wherein said open air comprises steam or a mixed gas containing steam and air (or oxygen).

10. A fuel reformer according to claim 1, wherein said liquid fuel comprises any one selected from diesel oil, gasoline kerosene, methanol, ethanol and GTE fuel, or a combination thereof.

11. A fuel reformer according to claim 1, wherein said liquid fuel comprises water, and said spraying device atomizes said water together with said liquid fuel.

12. A ultrasonic sprayer for a fuel reformer, which atomizes liquid fuel by generating ultrasonic vibrations.

13. A fuel reforming method which comprises steps of atomizing liquid fuel; and reforming said atomized fuel via catalytic reaction.

14. A fuel reforming method according to claim 13, wherein said atomizing step comprises a step of atomizing said liquid fuel via ultrasonic vibrations.

15. A fuel reforming method according to claim 13, which further comprises a step of mixing said atomized fuel with steam, and the reforming step comprises a step of performing a catalytic reaction of said steam and said atomized fuel with oxygen or air to reform the fuel.

16. A fuel reforming method which comprises a step of atomizing a mixture of liquid fuel and water; and a step of performing a catalytic reaction of said atomized fuel and water with oxygen or air to reform the fuel.

17. A fuel reformer according to claim 5, wherein said cooling agent comprises at least one selected from air and nitrogen.

18. A fuel reformer according to claim 8, wherein said open air comprises steam or a mixed gas containing steam and air (or oxygen).

19. A fuel reformer according to claim 10, wherein said liquid fuel comprises water, and said spraying device atomizes said water together with said liquid fuel.

20. A fuel reforming method according to claim 14, which further comprises a step of mixing said atomized fuel with steam, and the reforming step comprises a step of performing a catalytic reaction of said steam and said atomized fuel with oxygen or air to reform the fuel.
